(19) United States
(12) Patent Application Publication
(10) Pub. No.: US 2011/0320787 A1
(43) Pub. Date: Dec. 29, 2011

(54) Indirect Branch Hint

(75) Inventors: James Norris Dieffenderfer, Apex, NC (US); Michael William Morrow, Cary, NC (US)

(73) Assignee: QUALCOMM Incorporated, San Diego, CA (US)

(21) Appl. No.: 12/824,599

(22) Filed: Jun. 28, 2010

(51) Int. Cl. G06F 9/38

(52) U.S. Cl. 712/234; 712/E09.045

(57) ABSTRACT

A processor implements an apparatus and a method for predicting an indirect branch address. A target address generated by an instruction is automatically identified. A predicted next program address is prepared based on the target address before an indirect branch instruction utilizing the target address is speculatively executed. The apparatus suitably employs a register for holding an instruction memory address that is specified by a program as a predicted indirect address of an indirect branch instruction. The apparatus also employs a next program address selector that selects the predicted indirect address from the register as the next program address for use in speculatively executing the indirect branch instruction.

### FIELD OF THE INVENTION

The present invention relates generally to techniques for processing instructions in a processor pipeline and, more specifically, to techniques for generating an early indication of a target address for an indirect branch instruction.

### BACKGROUND OF THE INVENTION

Many portable products, such as cell phones, laptop computers, personal data assistants (PDAs) or the like, require the use of a processor executing a program supporting communication and multimedia applications. The processing system for such products includes a processor, a source of instructions, a source of input operands, and storage space for storing results of execution. For example, the instructions and input operands may be stored in a hierarchical memory configuration consisting of general purpose registers and multi-levels of caches, including, for example, an instruction cache, a data cache, and system memory.

In order to provide high performance in the execution of programs, a processor typically executes instructions in a pipeline optimized for the application and the process technology used to manufacture the processor. Processors also may use speculative execution to fetch and execute instructions beginning at a predicted branch target address. If the branch is mispredicted, the speculatively executed instructions must be flushed from the pipeline and the pipeline restarted at the correct path address. In many processor instruction sets, there is often an instruction that branches to a program destination address that is derived from the contents of a register. Such an instruction is generally named an indirect branch instruction. Due to the indirect branch dependence on the contents of a register, it is usually difficult to predict the branch target address since the register could have a different value each time the indirect branch instruction is executed. Since correcting a mispredicted indirect branch generally requires back tracking to the indirect branch instruction in order to fetch and execute the instruction on the correct branching path, the performance of the processor can be reduced thereby. Also, a misprediction indicates the processor incorrectly speculatively fetched and began processing of instructions on the wrong branching path causing an increase in power both for processing of instructions which are not used and for flushing them from the pipeline.

### SUMMARY OF THE DISCLOSURE

Among its several aspects, the present invention recognizes that it is advantageous to minimize the number of mispredictions that may occur when executing instructions to improve performance and reduce power requirements in a processor system. To such ends, an embodiment of the invention applies to a method for changing a sequential flow of a program. The method saves a target address identified by a first instruction and changes the speculative flow of execution to the target address after a second instruction is encountered, wherein the second instruction is an indirect branch instruction.

Another embodiment of the invention addresses a method for predicting an indirect branch address. A sequence of instructions is analyzed to identify a target address generated by an instruction of the sequence of instructions. A predicted next program address is prepared based on the target address before an indirect branch instruction utilizing the target address is speculatively executed.

Another aspect of the invention addresses an apparatus for indirect branch prediction. The apparatus employs a register for holding an instruction memory address that is specified by a program as a predicted indirect address of an indirect branch instruction. The apparatus also employs a next program address selector that selects the predicted indirect address from the register as the next program address for use in speculatively executing the indirect branch instruction.

A more complete understanding of the present invention, as well as further features and advantages of the invention, will be apparent from the following Detailed Description and the accompanying drawings.

### BRIEF DESCRIPTION OF THE DRAWINGS

FIG. 1 is a block diagram of an exemplary wireless communication system in which an embodiment of the invention may be advantageously employed;

FIG. 2 is a functional block diagram of a processor complex which supports predicting branch target addresses for indirect branch instructions in accordance with the present invention;

FIG. 3A is a general format for a 32-bit BHINT instruction that specifies a register having an indirect branch target address value in accordance with the present invention;

FIG. 3B is a general format for a 16-bit BHINT instruction that specifies a register having an indirect branch target address value in accordance with the present invention;

FIG. 4A is a code example for an approach to indirect branch prediction using a history of prior indirect branch executions in accordance with the present invention;

FIG. 4B is a code example for an approach to indirect branch prediction using the BHINT instruction of FIG. 3A for predicting an indirect branch target address in accordance with the present invention;

FIG. 5 illustrates an exemplary first indirect branch target address (BTA) prediction circuit in accordance with the present invention;

FIG. 6 is a code example for an approach using an automatic indirect-target inference method for predicting an indirect branch target address in accordance with the present invention;

FIG. 7 is a first indirect branch prediction (IBP) process suitably utilized to predict the branch target address of an indirect branch instruction in accordance with the present invention;

FIG. 8A illustrates an exemplary target tracking table (TTT);

FIG. 8B is a second indirect branch prediction (IBP) process suitably utilized to predict the branch target address of an indirect branch instruction in accordance with the present invention;

FIG. 9A illustrates an exemplary second indirect branch target address (BTA) prediction circuit in accordance with the present invention;

FIG. 9B illustrates an exemplary third indirect branch target address (BTA) prediction circuit in accordance with the present invention; and

FIGS. 10A and 10B is a code example for an approach using software code profiling method for predicting an indirect branch target address in accordance with the present invention.

### DETAILED DESCRIPTION

The present invention will now be described more fully with reference to the accompanying drawings, in which several embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

Computer program code or “program code” for being operated upon or for carrying out operations according to the teachings of the invention may be initially written in a high level programming language such as C, C++, JAVA®, Smalltalk, JavaScript®, Visual Basic®, TSQL, Perl, or in various other programming languages. A program written in one of these languages is compiled to a target processor architecture by converting the high level program code into a native assembler program. Programs for the target processor architecture may also be written directly in the native assembler language. A native assembler program uses instruction mnemonic representations of machine level binary instructions. Program code or computer readable medium as used herein refers to machine language code such as object code whose format is understandable by a processor.

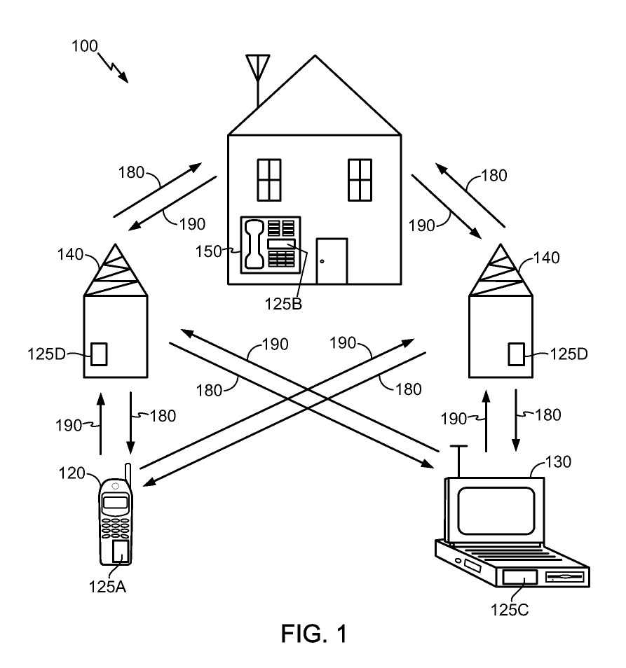

FIG. 1 illustrates an exemplary wireless communication system 100 in which an embodiment of the invention may be advantageously employed. For purposes of illustration, FIG. 1 shows three remote units 120, 130, and 150 and two base stations 140. It will be recognized that common wireless communication systems may have many more remote units and base stations. Remote units 120, 130, 150, and base stations 140 which include hardware components, software components, or both as represented by components 125A, 125C, 125B, and 125D, respectively, have been adapted to embody the invention as discussed further below. FIG. 1 shows forward link signals 180 from the base stations 140 to the remote units 120, 130, and 150 and reverse link signals 190 from the remote units 120, 130, and 150 to the base stations 140.

In FIG. 1, remote unit 120 is shown as a mobile telephone, remote unit 130 is shown as a portable computer, and remote unit 150 is shown as a fixed location remote unit in a wireless local loop system. By way of example, the remote units may alternatively be cell phones, pagers, walkie talkies, handheld personal communication system (PCS) units, portable data units such as personal data assistants, or fixed location data units such as meter reading equipment. Although FIG. 1 illustrates remote units according to the teachings of the disclosure, the disclosure is not limited to these exemplary illustrated units. Embodiments of the invention may be suitably employed in any processor system having indirect branch instructions.

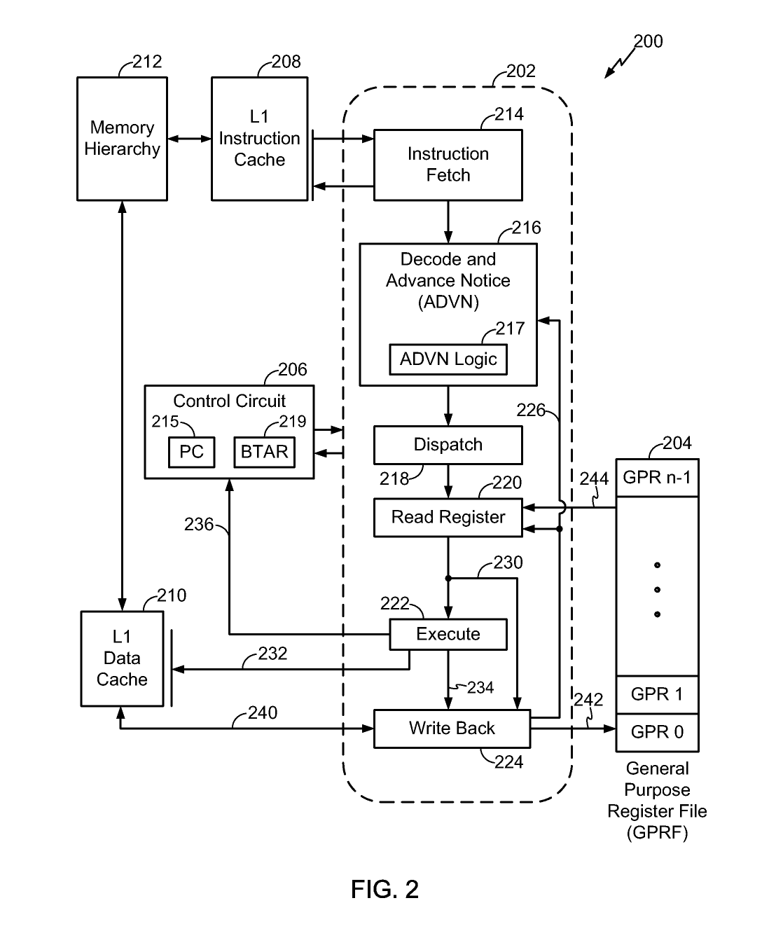

FIG. 2 is a functional block diagram of a processor complex 200 which supports predicting branch target addresses for indirect branch instructions in accordance with the present invention. The processor complex 200 includes processor pipeline 202, a general purpose register file (GPRF) 204, a control circuit 206, an L1 instruction cache 208, an L1 data cache 210, and a memory hierarchy 212. Peripheral devices which may connect to the processor complex are not shown for clarity of discussion. The processor complex 200 may be suitably employed in hardware components 125A-125D of FIG. 1 for executing program code that is stored in the L1 instruction cache 208 and the memory hierarchy 212. The processor pipeline 202 may be operative in a general purpose processor, a digital signal processor (DSP), an application specific processor (ASP) or the like. The various components of the processing complex 200 may be implemented using application specific integrated circuit (ASIC) technology, field programmable gate array (FPGA) technology, or other programmable logic, discrete gate or transistor logic, or any other available technology suitable for an intended application.

The processor pipeline 202 includes six major stages, an instruction fetch stage 214, a decode and predict stage 216, a dispatch stage 218, a read register stage 220, an execute stage 222, and a write back stage 224. Though a single processor pipeline 202 is shown, the processing of instructions with indirect branch target address prediction of the present invention is applicable to super scalar designs and other architectures implementing parallel pipelines. For example, a super scalar processor designed for high clock rates may have two or more parallel pipelines and each pipeline may divide the instruction fetch stage 214, the decode and predict stage 216 having predict logic circuit 217, the dispatch stage 218, the read register stage 220, the execute stage 222, and the write back stage 224 into two or more pipelined stages increasing the overall processor pipeline depth in order to support a high clock rate.

Beginning with the first stage of the processor pipeline 202, the instruction fetch stage 214, associated with a program counter (PC) 215, fetches instructions from the L1 instruction cache 208 for processing by later stages. If an instruction fetch misses in the L1 instruction cache 208, in other words, the instruction to be fetched is not in the L1 instruction cache 208, the instruction is fetched from the memory hierarchy 212 which may include multiple levels of cache, such as a level 2 (L2) cache, and main memory. Instructions may be loaded to the memory hierarchy 212 from other sources, such as a boot read only memory (ROM), a hard drive, an optical disk, or from an external interface, such as, the Internet. A fetched instruction then is decoded in the decode and predict stage 216 with the predict logic circuit 217 providing additional capabilities for predicting an indirect branch target address value as described in more detail below. Associated with predict logic circuit 217 is a branch target address register (BTAR) 219 which may be located in the control circuit 206 as shown in FIG. 2, though not limited to such placement. For example, the BTAR 219 may suitably be located within the decode and predict stage 216.

The dispatch stage 218 takes one or more decoded instructions and dispatches them to one or more instruction pipelines, such as utilized, for example, in a superscalar or a multi-threaded processor. The read register stage 220 fetches data operands from the GPRF 204 or receives data operands from a forwarding network 226. The forwarding network 226 provides a fast path around the GPRF 204 to supply result operands as soon as they are available from the execution stages. Even with a forwarding network, result operands from a deep execution pipeline may take three or more execution cycles. During these cycles, an instruction in the read register stage 220 that requires result operand data from the execution pipeline, must wait until the result operand is available. The execute stage 222 executes the dispatched instruction and the write-back stage 224 writes the result to the GPRF 204 and may also send the results back to read register stage 220 through the forwarding network 226 if the result is to be used in a following instruction. Since results may be received in the write back stage 224 out of order compared to the program order, the write back stage 224 uses processor facilities to preserve the program order when writing results to the GPRF 204. A more detailed description of the processor pipeline 202 for predicting the target address of an indirect branch instruction is provided below with detailed code examples.

The processor complex 200 may be configured to execute instructions under control of a program stored on a computer readable storage medium. For example, a computer readable storage medium may be either directly associated locally with the processor complex 200, such as may be available from the L1 instruction cache 208 and the memory hierarchy 212 through, for example, an input/output interface (not shown). The processor complex 200 also accesses data from the L1 data cache 210 and the memory hierarchy 212 in the execution of a program. The computer readable storage medium may include random access memory (RAM), dynamic random access memory (DRAM), synchronous dynamic random access memory (SDRAM), flash memory, read only memory (ROM), programmable read only memory (PROM), erasable programmable read only memory (EPROM), electrically erasable programmable read only memory (EEPROM), compact disk (CD), digital video disk (DVD), other types of removable disks, or any other suitable storage medium.

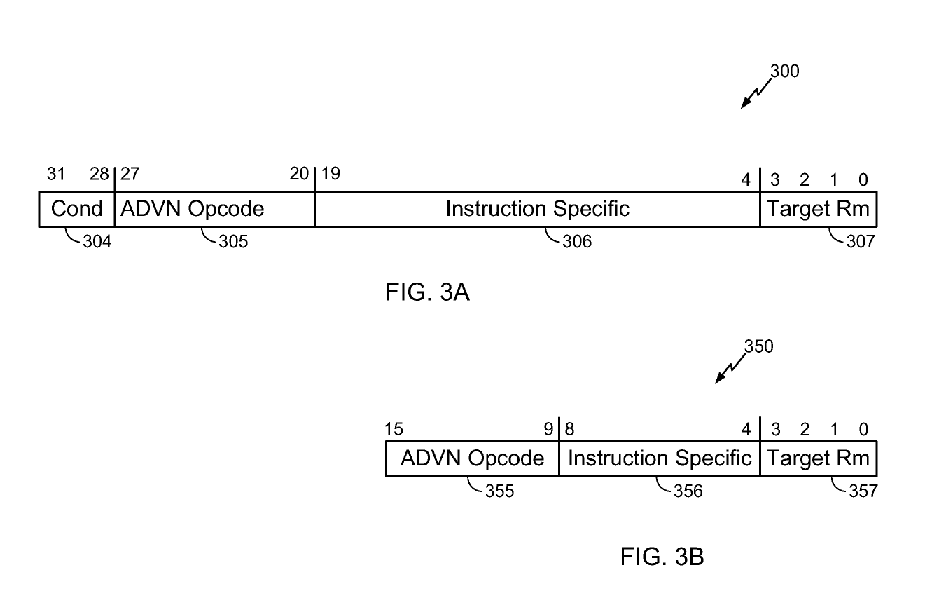

FIG. 3A is a general format for a 32-bit BHINT instruction 300 that specifies a register identified by a programmer or a software tool as holding an indirect branch target address value in accordance with the present invention. The BHINT instruction 300 is illustrated with a condition code field 304 as utilized by a number of instruction set architectures (ISAs) to specify whether the instruction is to be executed unconditionally or conditionally based on a specified flag or flags. An opcode 305 identifies the instruction as a branch hint instruction having at least one branch target address register field, Rm 307. An instruction specific field 306 allows for opcode extensions and other instruction specific encodings. In processors having such an ISA with instructions that conditionally execute according to a specified condition code field in the instruction, the condition field of the last instruction affecting the branch target address register Rm would generally be used as the condition field for the BHINT instruction, though not limited to such a specification.

The teachings of the invention are applicable to a variety of instruction formats and architectural specification. For example, FIG. 3B is a general format for a 16-bit BHINT instruction 350 that specifies a register having indirect branch target address value in accordance with the present invention. The 16-bit BHINT instruction 350 is similar to the 32-bit BHINT instruction 300 having an opcode 355, a branch target address register field Rm 357, and instruction specific bits 356. It is also noted that other bit formats and instruction widths may be utilized to encode a BHINT instruction.

General forms of indirect branch type instructions may be advantageously employed and executed in processor pipeline 202, for example, branch on register Rx (BX), add PC, move Rx PC, and the like. For purposes of describing the present invention the BX Rx form of an indirect branch instruction is used in code sequence examples as described further below.

It is noted that other forms of branch instructions are generally provided in an ISA, such as a branch instruction having an instruction specified branch target address (BTA), a branch instruction having a BTA calculated as a sum of an instruction specified offset address and a base address register, and the like. In support of such branch instructions, the processor pipeline 202 may utilize branch history prediction techniques that are based on tracking, for example, conditional execution status of prior branch instruction executions and storing such execution status for use in predicting future execution of these instructions. The processor pipeline 202 may support such branch history prediction techniques and additionally support the use of the BHINT instruction as an aid in predicting indirect branches. For example, the processor pipeline 202 may use the branch history prediction techniques until a BHINT instruction is encountered which then overrides the branch target history prediction techniques using the BHINT facilities as described herein.

In other embodiments of the present invention, the processor pipeline 202 may also be set up to monitor the accuracy of using the BHINT instruction and when the BHINT identified target address was incorrect for one or more times, to ignore the BHINT instruction for subsequent encounters of the same indirect branch. It is also noted that for a particular implementation of a processor supporting an ISA having a BHINT instruction, the processor may treat an encountered BHINT instruction as a no operation (NOP) instruction or flag the detected BHINT instruction as undefined. Further, a BHINT instruction may be treated as a NOP in a processor pipeline having a branch history prediction circuit with sufficient hardware resources to track branches encountered during execution of a section of code and enable the BHINT instruction as described below for sections of code which exceeds the hardware resources available to the branch history prediction circuit. In addition, advantageous automatic indirect-target inference methods are presented for predicting the indirect branch target address as described below.

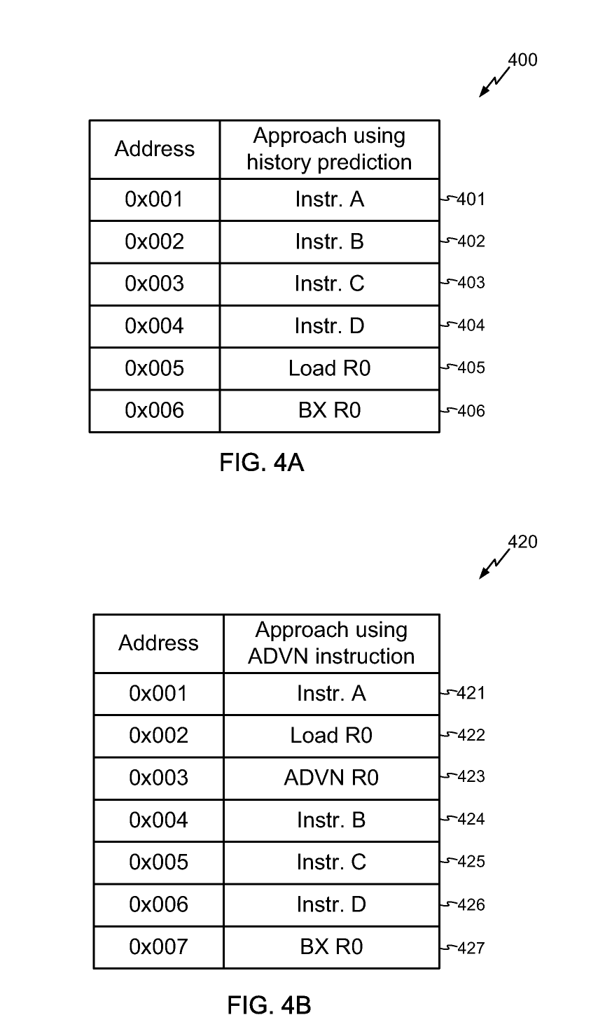

FIG. 4A is a code example 400 for an approach to indirect branch prediction that uses a general history approach for predicting indirect branch executions if no BHINT instruction is encountered in accordance with the present invention. The execution of the code example 400 is described with reference to the processor complex 200. Instructions A-D 401-404 may be a set of sequential arithmetic instructions, for purposes of this example, that, based on an analysis of the instructions A-D 401-404, do not affect the register R0 in the GPRF 204. Register R0 is loaded by the load R0 instruction 405 with the target address for the indirect branch instruction BX R0 406. Each of the instructions 401-406 are specified to be unconditionally executed, for purposes of this example. It is also assumed that the load R0 instruction 405 is available in the L1 instruction cache 208, such that when instruction A 401 completes execution in the execute stage 222, the load R0 instruction 405 has been fetched in the fetch stage 214. The indirect branch BX R0 instruction 406 is then fetched while the load R0 instruction 405 is decoded in the decode and predict stage 216. In the next pipeline stage, the load R0 instruction 405 is prepared to be dispatched for execution and the BX R0 instruction 406 is decoded. Also, in the decode and predict stage 216, a prediction is made based on a history of prior indirect branch executions whether the BX R0 instruction 406 is taken or not taken and a target address for the indirect branch is also predicted. For this example, the BX R0 instruction 406 is specified to be unconditionally “taken” and the predict logic circuit 217 is only required to predict the indirect branch target address as address X. Based on this prediction, the processor pipeline 202 is directed to begin speculatively fetching instructions beginning from address X, which given the “taken” status is generally a redirection from the current instruction addressing. The processor pipeline 202 also flushes any instruction in the pipeline following the indirect branch BX R0 instruction 406 if those instructions are not associated with the instructions beginning at address X. The processor pipeline 202 continues to fetch instructions until it can be determined in the execute stage whether the predicted address X was correctly predicted.

While processing instructions, stall situations may be encountered, such as that which could occur with the execution of the load R0 instruction 405. The execution of the load R0 instruction 405 may return the value from the L1 data cache 210 without delay if there is a hit in the L1 data cache. However, the execution of a load R0 instruction 405 may take a significant number of cycles if there is a miss in the L1 data cache 210. A load instruction may use a register from the GPRF 204 to supply a base address and then add an immediate value to the base address in the execute stage 222 to generate an effective address. The effective address is sent over data path 232 to the L1 data cache 210. With a miss in the L1 data cache 210, the data must be fetched from the memory hierarchy 212 which may include, for example, an L2 cache and main memory. Further, the data may miss in the L2 cache leading to a fetch of the data from the main memory. For example, a miss in the L1 data cache 210, a miss in an L2 cache in the memory hierarchy 212, and an access to main memory may require hundreds of CPU cycles to fetch the data. During the cycles it takes to fetch the data after an L1 data cache miss, the BX R0 instruction 406 is stalled in the processor pipeline 202 until the in flight operand is available. The stall may be considered to occur in the read register stage 220 or the beginning of the execute stage 222.

It is noted that in processors having multiple instruction pipelines, the stall of the load R0 instruction 405 may not stall the speculative operations occurring in any other pipelines. Due to the length of a stall on a miss in the L1 D cache 210, a significant number of instructions may be speculatively fetched, which if there was an incorrect prediction of indirect branch target address may significantly affect performance and power use. A stall may be created in a processor pipeline by use of a hold circuit which is part of the control circuit 206 of FIG. 2. The hold circuit generates a hold signal that may be used, for example, to gate pipeline stage registers to stall an instruction in a pipeline. For the processor pipeline 202 of FIG. 2, a hold signal may be activated, for example, in the read register stage if not all inputs are available such that the pipeline is held pending the arrival of the inputs necessary to complete the execution of the instruction. The hold signal is released when all the necessary operands become available.

Upon resolution of the miss, the load data is sent over path 240 to a write back operation as part of the write back stage 224. The operand is then written to the GPRF 204 and may also be sent to the forwarding network 226 described above. The value for R0 may now be compared to the predicted address X to determine whether the speculatively fetched instructions need to be flushed or not. Since the register used to store the branch target address could have a different value each time the indirect branch instruction is executed, there is a high probability that the speculatively fetched instructions would be flushed using current prediction approaches.

FIG. 4B is a code example 420 for an approach to indirect branch prediction using the BHINT instruction of FIG. 3A for predicting an indirect branch target address in accordance with the present invention. Based on the previously noted analysis that the instructions A-D 401-404 of FIG. 4A do not affect the branch target address register R0, the load R0 instruction 405 can be moved up in the instruction sequence, for example, to be placed after instruction A 421 in the code example of FIG. 4B. In addition, a BHINT R0 instruction 423, such as the BHINT instruction 300 of FIG. 3A, is placed directly after the load R0 instruction 422 as a look ahead aid for predicting the branch target address for the indirect BX R0 instruction 427.

As the new instruction sequence 421-427 of FIG. 4B flows through the processor pipeline 202, the BHINT R0 instruction 423 will be in the read stage 220 when the load R0 instruction 422 is in the execute stage and instruction D 426 will be in the fetch stage 214. For the situation where the load R0 instruction 422 hits in the L1 data cache 210, the value of R0 is known by the end of the load R0 execution and with the R0 value fast forward over the forwarding network 226 to the read stage, the R0 value is also known at the end of the read stage 220 or by the beginning of the execute stage for the BHINT R0 instruction. The determination of the R0 value prior to the indirect branch instruction entering the decode and predict stage 216 allows the prediction logic circuit 217 to choose the determined R0 value as the branch target address for the BX R0 instruction 427 without any additional cycle delay. It is noted that for the processor pipeline 202, the load R0 instruction and the BHINT R0 instruction could have been placed after instruction B without causing any further delay for the case where there is a hit in the L1 data cache 210. However, if there was a miss in the L1 data cache, a stall situation would be initiated. For this case of a miss in the L1 data cache 210, the load R0 and BHINT R0 instructions would need to have been placed, if possible, an appropriate number of miss delay cycles before the BX R0 instruction based on the pipeline depth to avoid causing any further delays.

Generally, placement of the BHINT instructions is N cycles before the BX instruction is decoded, where N is the number of stages between an instruction fetch stage and an execute stage, such as the instruction fetch 214 and the execute stage 222. In the exemplary processor pipeline 202 with use of the forwarding network 226, N is two and, without use of the forwarding network 226, N is three. For processor pipelines using a forwarding network for example, if the BX instruction is preceded by N equal to two instructions before the BHINT instruction, then the BHINT target address register Rm value is determined at the end of the read register stage 220 due to the forwarding network 226. In an alternate embodiment for a processor pipeline not using a forwarding network 226 for BHINT instruction use, for example, if the BX instruction is preceded by N equal to three instructions before the BHINT instruction, then the BHINT target address register Rm value is determined at the end of the execute stage 222 as the BX instruction enters the decode and predict stage 216. The number of instructions N may also depend on additional factors, including stalls in the upper pipeline, such as delays in the instruction fetch stage 214, instruction issue width which may vary up to K instructions issued in a super scalar processor, and interrupts that come between the BHINT and the BX instructions, for example. In general, an ISA may recommend the BHINT instruction be scheduled as early as possible, to minimize the effect of such factors.

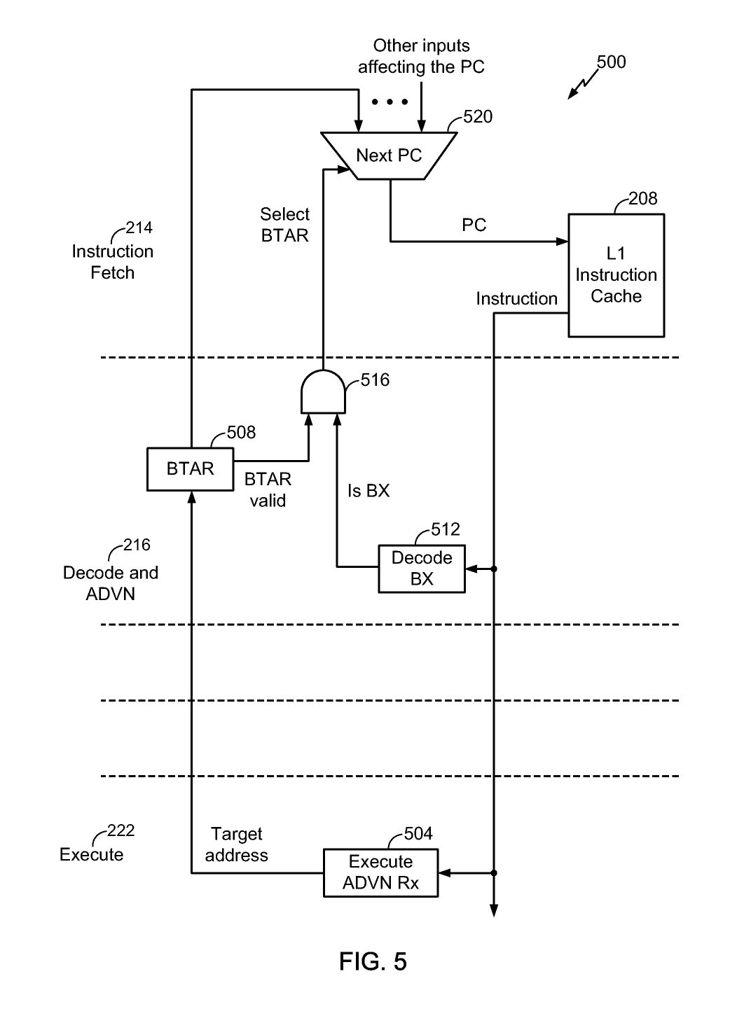

FIG. 5 illustrates an exemplary first indirect branch target address (BTA) prediction circuit 500 in accordance with the present invention. The first indirect BTA prediction circuit 500 includes a BHINT execute circuit 504, a branch target address register (BTAR) circuit 508, a BX decode circuit 512, a select circuit 516, and a next program counter (PC) circuit 520. Upon execution of a BHINT Rx instruction in BHINT execution circuit 504, the value of Rx is loaded into the BTAR circuit 508. When a BX instruction is decoded in BX decode circuit 512 and if the BTAR is valid as selected by select circuit 516, the BTA value in the BTAR circuit 508 is used as the next fetch address by the next PC circuit 520. A BTAR valid indication may also be used to stop fetching while the BTAR valid is active saving power that would be associated with fetching instructions at a wrong address.

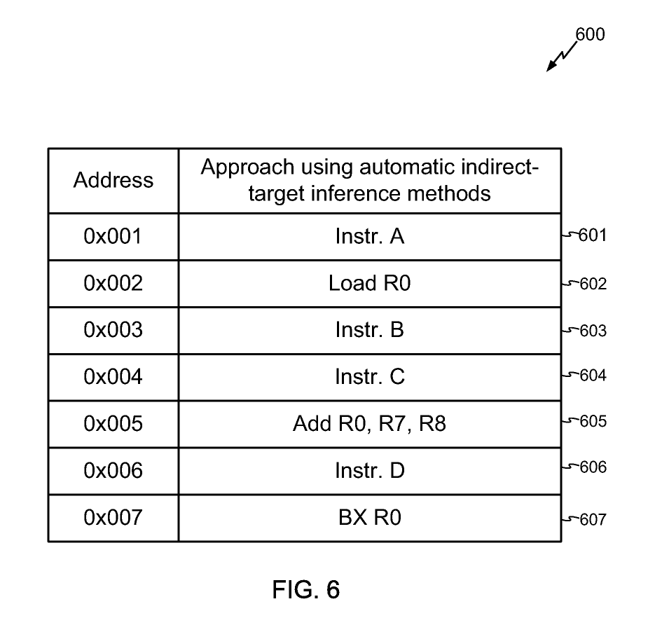

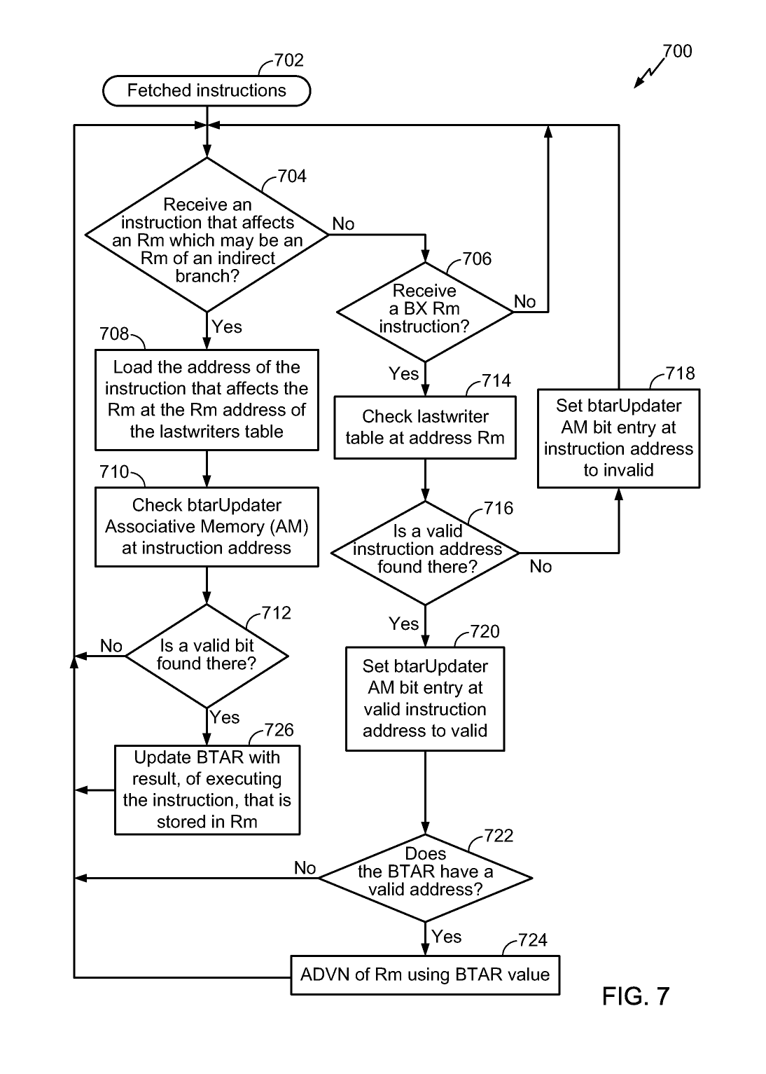

FIG. 6 is a code example 600 for an approach using an automatic indirect-target inference method for predicting an indirect branch target address in accordance with the present invention. In the code sequence 601-607, instructions A 601, B 603, C 604, and D 606 are the same as previously described and thus, do not affect a branch target address register. Two instructions, a load R0 instruction 602 and an add R0, R7, R8 instruction 605, affects the branch target register R0 of this example. The indirect branch instruction BX R0 607 is the same as used in the previous examples of FIGS. 4A and 4B. In the code example 600, even though both the load R0 instruction 602 and the add R0, R7, R8 instruction 605 affect the BTA register R0, the add R0, R7, R8 instruction 605 is the last instruction that affects the BTA.

By tracking the execution pattern of the code sequence 600, an automatic indirect-target inference method circuit may predict with reasonable accuracy whether the latest value of R0 at the time the BX R0 instruction 607 enters the decode and predict stage 216 should be used as the predicted BTA. In one embodiment, the last value written to R0 would be used as the value for the BX R0 instruction when it enters the decode and predict stage 216. This embodiment is based on an assessment that for the code sequence associated with this BX R0 instruction, the last value written to R0 could be predicted to be the correct value a high percentage of the time.

FIG. 7 is a first indirect branch prediction (IBP) process 700 suitably utilized to predict the branch target address of an indirect branch instruction in accordance with the present invention. The first IBP process 700 utilizes a lastwriter table that is addressable, or indexed, by a register file number, such that a lastwriter table associated with a register file having 32 entries R0 to R31 would be addressable by indexed values 0-31. Similarly, if a register file had less entries, such as 16 entries or, for example, 14 entries R0-R13, then the lastwriter table would be addressable by indexed values 0-13. Each of the entries in the lastwriter table stores an instruction address. The first IBP process 700 also utilizes a branch target address register updater associative memory (BTARU) with entries accessed by an instruction address and containing a valid bit per entry. Prior to entering the first IBP process 700, the lastwriter table is initialized to invalid instruction addresses, such as zero where instruction addresses for IBP code sequences would normally not be found and the BTARU entries are initialized to an invalid state.

The first IBP process 700 begins with a fetched instruction stream 702. At decision block 704, a determination is made whether an instruction is received that writes any register Rm that may be a target register of an indirect branch instruction. For example, in a processor having a 14 entry register file with registers R0-R13, instructions that write to any of the registers R0-R13 would be kept track of as possible target registers of an indirect branch instruction. For techniques that monitor multiple passes of sections of code having an indirect branch instruction, a specific Rm may be determined by identifying the indirect branch instruction on the first pass. If the instruction received does not affect an Rm, the first IBP process 700 proceeds to decision block 706. At decision block 706, a determination is made whether the instruction received is an indirect branch instruction, such as a BX Rm instruction. If the instruction received is not an indirect branch instruction, the first IBP process 700 proceeds decision block 704 to evaluate the next received instruction.

Returning to decision block 704, if the instruction received does affect an Rm, the first IBP process 700 proceeds to block 708. At block 708, the address of the instruction that affects the Rm is loaded at the Rm address of the lastwriter table. At block 710, the BTARU is checked for a valid bit at the instruction address. At decision block 712, a determination is made whether a valid bit was found at an instruction address entry in the BTARU. If a valid bit was not found, such as may occur on a first pass through process blocks 704, 708, and 710, the first IBP process returns to decision block 704 to evaluate the next received instruction.

Returning to decision block 706, if an indirect branch instruction, such as a BX Rm instruction, is received the first IBP process 700 proceeds to block 714. At block 714, the lastwriter table is checked for a valid instruction address at address Rm. At decision block 716, a determination is made whether a valid instruction address is found at the Rm address. If a valid instruction address is not found, the first IBP process 700 proceeds to block 718. At block 718, the BTARU bit entry at the instruction address is set to invalid and the first IBP process 700 returns to decision block 704 to evaluate the next received instruction.

Returning to decision block 716, if a valid instruction address is found, the first IBP process 700 proceeds to block 720. If there is a pending update, the first IBP process 700 may stall until the pending update is resolved. At block 720, the BTARU bit entry at the instruction address is set to valid and the first IBP process 700 proceeds to decision block 722. At decision block 722, a determination is made whether the branch target address register (BTAR) has a valid address. If the BTAR has a valid address the first IBP process 700 proceeds to block 724. At block 724, indirect branch instruction Rm is predicted using the stored BTAR value and the first IBP process 700 returns to decision block 704 to evaluate the next received instruction. Returning to decision block 722, if the BTAR is determined to not have a valid address, the first IBP process 700 returns to decision block 704 to evaluate the next received instruction.

Returning to decision block 704, if the instruction received does affect the Rm of an indirect branch instruction, such as may occur on a second pass through the first IBP process 700, the first IBP process 700 proceeds to block 708. At block 708, the address of the instruction that affects the Rm is loaded at the Rm address of the lastwriter table. At block 710, the BTARU is checked for a valid bit at the instruction address. At decision block 712, a determination is made whether a valid bit was found at an instruction address entry in the BTARU. If a valid bit was found, such as may occur on the second pass through process blocks 704, 708, and 710, the first IBP process 700 proceeds to block 726. At block 726, the branch target address register (BTAR), such as BTAR 219 of FIG. 2, is updated with a BTAR updater result of executing the instruction that is stored in Rm. The first IBP process 700 then returns to decision block 704 to evaluate the next received instruction.

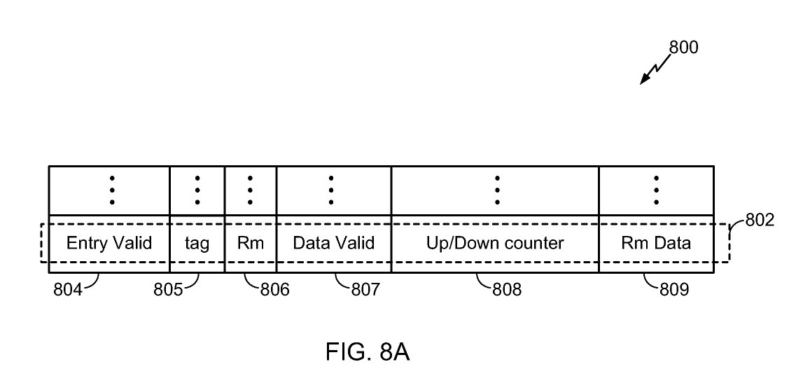

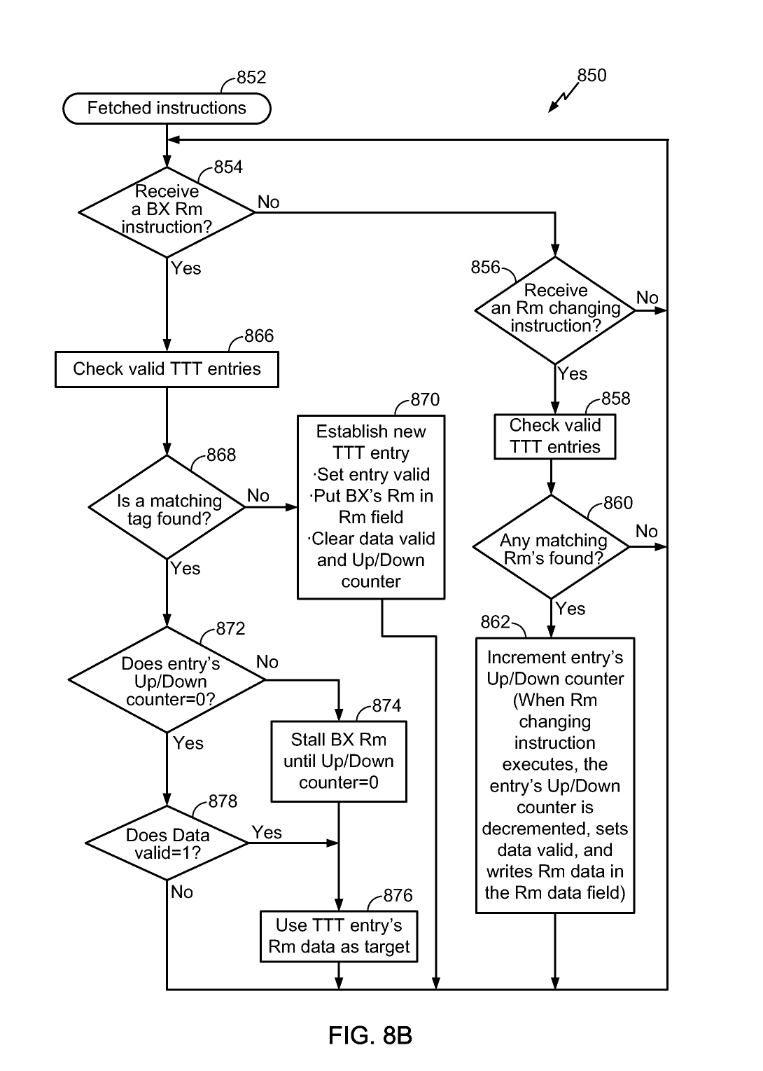

FIG. 8A illustrates an exemplary target tracking table (TTT) 800 with a TTT entry 802 having six fields that include a entry valid bit 804, a tag field 805, a register Rm address 806, a data valid bit 807, and up/down counter value 808, and an Rm data field 809. The TTT 800 may be stored in a memory, for example, in the control circuit 206, that is accessible by the decode and predict stage 216 and other pipe stages of the processor pipeline 202. For example, lower pipe stages, such as the execute stage 222, write Rm data into the Rm data field 809. As described in more detail below, an indirect branch instruction allocates a TTT entry when it is fetched and does not have a valid matching tag already in the TTT table. The tag field 805 may be a full instruction address or a portion thereof. Instructions that affect register values check valid entries in the TTT 800 for a matching Rm field as specified in Rm address 806. If a match is found, an indirect branch instruction to an address specified in that Rm has an established entry, such as TTT entry 802, in the TTT table 800.

FIG. 8B is a second indirect branch prediction (IBP) process 850 suitably utilized to predict the branch target address of an indirect branch instruction in accordance with the present invention. The second IBP process 850 begins with a fetched instruction stream 852. At decision block 854, a determination is made whether an indirect branch (BX Rm) instruction is received. If a BX Rm instruction is not received the second IBP process 850 proceeds to decision block 856. At decision block 856, a determination is made whether the instruction received affects an Rm register. The determination being made here is whether or not the received instruction will update any registers that could potentially be used by a BX instruction. If the instruction received does not affect an Rm register, the second IBP process 850 proceeds to decision block 854 to evaluate the next received instruction.

Returning to decision block 856, if the instruction received does affect an Rm register, the second IBP process 850 proceeds to block 858. At block 858, the TTT 800 is checked for valid entries to see if the received instruction will actually change a register that a BX instruction will need. At decision block 860, a determination is made whether any matching Rm's have been found in the TTT 800. If at least one matching Rm has not been found in the TTT 800, the second IBP process 850 returns decision block 854 to evaluate the next received instruction. However, if at least one matching Rm was found in the TTT 800, the second IBP process 850 proceeds to block 862. At block 862, the up/down counter associated with the entry is incremented. The up/down counter indicates how many instructions are in flight that will change that particular Rm. It is noted that when an Rm changing instruction executes, the entry's up/down counter value 808 is decremented, the data valid bit 807 is set, and Rm data result of execution is written to the Rm data field 809. If register changing instructions complete out of order, then a latest register changing instruction cancels an older instruction's write to the Rm data field, thereby avoiding a write after write hazard. For processor instruction set architectures (ISAs) that have non-branch conditional instructions, a non-branch conditional instruction may have a condition that evaluates to a no-execute state. Thus, for the purposes of evaluating an entry's up/down counter value 808, the target register Rm of a non-branch conditional instruction that evaluates to no-execute may be read as a source operand. The Rm value that is read has the latest target register Rm value. That way, even if the non-branch conditional instruction having an Rm with a matched valid tag is not executed, the Rm data field 809 may be updated with the latest value and the up/down counter value 808 is accordingly decremented. The second IBP process 850 then returns to decision block 854 to evaluate the next received instruction.

Returning to decision block 854, if the received instruction is a BX Rm instruction, the second IBP process 850 proceeds to block 866. At block 866, the TTT 800 is checked for valid entries. At decision block 868, a determination is made whether a matching tag has been found in the TTT 800. If a matching tag was not found the second IBP process 850 proceeds to block 870. At block 870, a new entry is established in the TTT 800, which includes setting the new entry valid bit 804 to a valid indicating value, placing the BX's Rm in the Rm field 806, clearing the data valid bit 807, and clearing the up/down counter associated with the new entry. The second IBP process 850 then returns to decision block 854 to evaluate the next received instruction.

Returning to decision block 868, if a matching tag is found the second IBP process 850 proceeds to decision block 872. At decision block 872, a determination is made whether the entry's up/down counter is zero. If the entry's up/down counter is not zero, there are Rm changing instructions still in flight and the second IBP process 850 proceeds to step 874. At step 874, the BX instruction is stalled in the processor pipeline until the entry's up/down counter has been decremented to zero. At block 876, the TTT entry's Rm data which is the last change to the Rm data is used as the target for the indirect branch BX instruction. The second IBP process 850 then returns to decision block 854 to evaluate the next received instruction.

Returning to decision block 872, if the entry's up/down counter is equal to zero, the second IBP process 850 proceeds to decision block 878. At decision block 878, a determination is made whether the entry's data valid bit is equal to a one. If the entry's data valid bit is equal to a one, the second IBP process 850 proceeds to block 876. At block 876, the TTT entry's Rm data is used as the target for the indirect branch BX instruction. The second IBP process 850 then returns to decision block 854 to evaluate the next received instruction.

Returning to decision block 878, if the entry's data valid bit is not equal to a one, the second IBP process 850 returns to decision block 854 to evaluate the next received instruction. In a first alternative, the TTT entry's Rm data may be used as the target for the indirect branch BX instruction, since the BX Rm tag matches a valid entry and the up/down counter value is zero. In a second alternative, the processor pipeline 202 is directed to fetch instructions according to a not taken path to avoid fetching down an incorrect path. Since the data in the Rm data field is not valid, there is no guarantee the Rm data even points to executable memory or memory that has been authorized for access. Fetching down the sequential path, the not taken path, is most likely to memory permitted to be accessed. In an advantageous third alternative, the processor pipeline 202 is directed to stop fetching after the BX instruction in order to save power and wait for a BX correction sequence to reestablish the fetch operations.

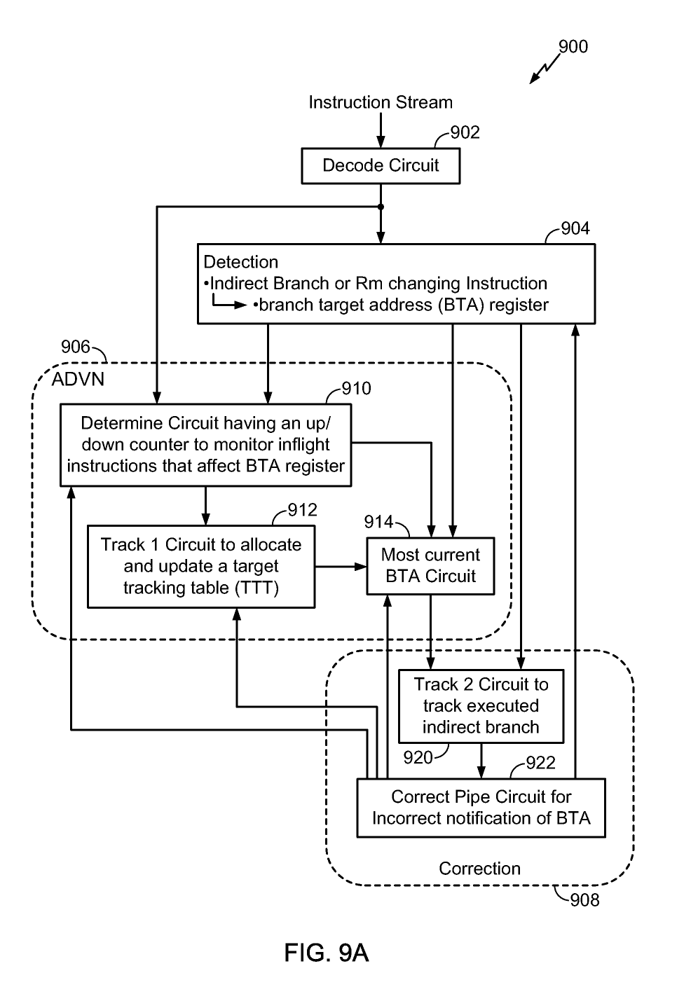

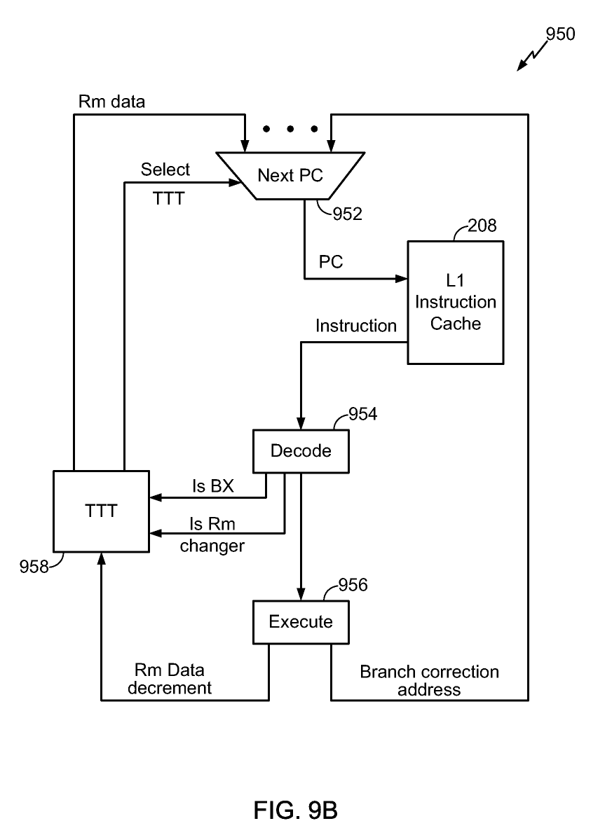

FIG. 9A illustrates an exemplary second indirect branch target address (BTA) prediction circuit 900 in accordance with the present invention. The BTA prediction circuit 900 is associated with the processor pipeline 202 and the control circuit 206 of the processor complex 200 of FIG. 2 and operates according to the second IBP process 850. The second indirect BTA prediction circuit 900 is comprised of a decode circuit 902, a detection circuit 904, a prediction circuit 906, and a correction circuit 908 with basic control signal paths shown between the circuits. The prediction circuit 906 includes a determine circuit 910, a track 1 circuit 912, and a predict BTA circuit 914. The correction circuit 908 includes a track 2 circuit 920 and a correct pipe circuit 922.

The decode circuit 902 decodes incoming instructions from the instruction fetch stage 214 of FIG. 2. The detection circuit 904 monitors the decoded instructions for an indirect branch instruction or for an Rm changing instruction. Upon detecting an indirect branch instruction for the first time, the prediction circuit 906 establishes a new target tracking table (TTT) entry, such as TTT entry 802 of FIG. 8A and identifies the branch target address (BTA) register specified by the detected indirect branch instruction as described at block 870 of FIG. 8B. Upon detecting an Rm changing instruction associated with a valid TTT entry and a matching Rm value, the up/down counter value 808 is incremented and when the Rm changing instruction is executed the up/down counter value 808 is decremented according to block 862. Upon a successive detection of an indirect branch instruction, the prediction circuit 906 follows the operations described by blocks 872-878 of FIG. 8B. The correction circuit 908 flushes the pipeline on an incorrect BTA prediction.

In the prediction circuit 906, the predict BTA circuit 914 uses a TTT entry, such as TTT entry 802 of FIG. 8A, for example, to predict the BTA for the indirect branch instruction, such as the BX R0 instruction 607. The predicted BTA is used to redirect the processor pipeline 202 to fetch instructions beginning at the predicted BTA for speculative execution.

In the correction circuit 908, the track 2 circuit 920 monitors the execute stage 222 of the processor pipeline 202 for execution status of the BX R0 instruction 607. If the BTA was correctly predicted, the speculatively fetched instructions are allowed to continue in the processor pipeline. If the BTA was not predicted correctly, the speculatively fetched instructions are flushed from the processor pipeline and the pipeline is redirected back to a correct instruction sequence. The detection circuit 904 is also informed of the incorrect prediction status and in response to this status may be programmed to stop identifying this particular indirect branch instruction for prediction. In addition, the prediction circuit 906 is informed of the incorrect prediction status and in response to this status may be programmed to only allow prediction for particular entries of the TTT 800.

FIG. 9B illustrates an exemplary third indirect branch target address (BTA) prediction circuit 950 in accordance with the present invention. The third indirect BTA prediction circuit 950 includes a next program counter (PC) circuit 952, a decode circuit 954, an execute circuit 956, and a target tracking table (TTT) circuit 958 and illustrates aspects of addressing an instruction cache, such as the L1 instruction cache 208 of FIG. 2, to fetch an instruction that is forward to the decode circuit 954. The third indirect BTA prediction circuit 950 operates according to the second IBP process 850. For example, the decode circuit 954 detects an indirect branch, such as a BX instruction, or an Rm changing instruction and notifies the TTT circuit 958 that a BX instruction or an Rm changer instruction has been detected and supplies appropriate information, such as a BX instruction's Rm value. The TTT circuit 958 also contains an up/down counter that increments or decrements as described at block 862 of FIG. 8B to provide the up/down counter value 808. The execute circuit 956 provides an Rm data value and a decrement indication upon the execution of an Rm changer instruction. The execute circuit 956 also provides a branch correction address depending upon the status of success or failure of a prediction. As described at block 876, an entry in the TTT circuit 958 is selected and the Rm data field of the selected entry is supplied as part of a target address to the next PC circuit 952.

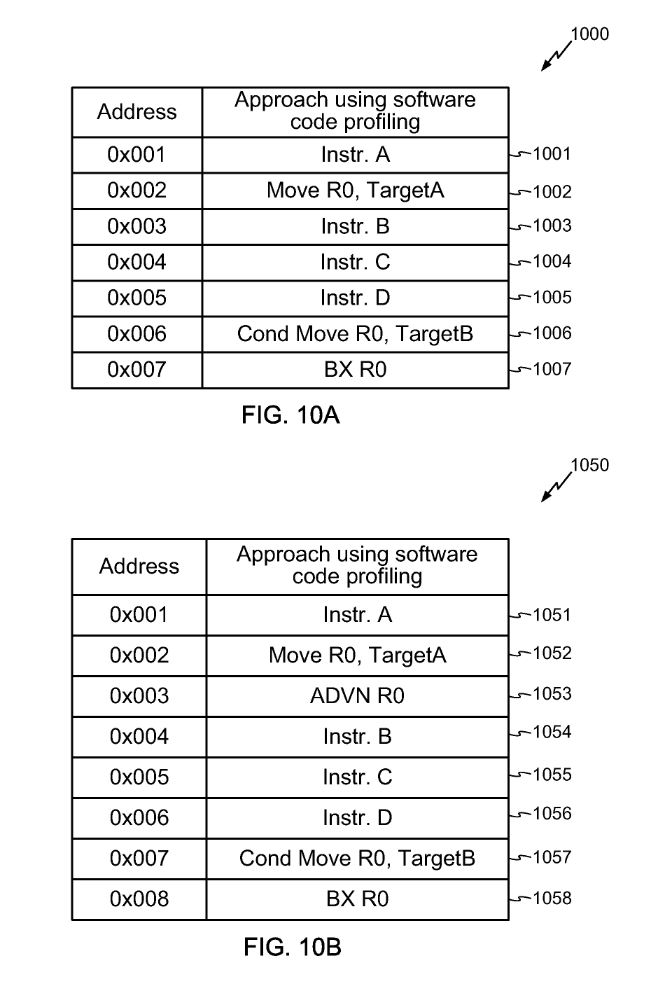

FIG. 10A is a code example 1000 for an approach using software code profiling method for predicting an indirect branch target address in accordance with the present invention. In the code sequence 1001-1007, instructions A 1001, B 1003, C 1004, and D 1005 are the same as previously described and thus, do not affect a branch target address register. Instruction 1002 is a Move R0, TargetA instruction 1002, which unconditionally moves a value from TargetA to register R0. Instruction 1006 is a conditional Move R0, TargetB instruction 1006, which conditionally executes approximately 10% of the time. The conditions used for determining instruction execution may be developed from condition flags set by the processor in the execution of various arithmetic, logic, and other function instructions as typically specified in the instruction set architecture. These condition flags may be stored in a program readable flag register or a condition code (CC) register located in control logic 206 which may also be part of a program status register. The indirect branch instruction BX R0 1007 is the same as used in the previous examples of FIGS. 4A and 4B.

In the code example 1000, the conditional move R0, targetB instruction 1006 may affect the BTA register R0 depending on whether it executes or not. Two possible situations are considered as shown in the following table:

| Line | Move R0, TargetA | Conditional Move R0, TargetB |
|---|---|---|
| 1 | Execute | NOP |
| 2 | Execute | Execute |

In the code sequence 1000, the last instruction that is able to affect the indirect BTA is the conditional move R0, targetB instruction 1006 and if it executes, line 2 in the above table, it does not matter whether the move R0, targetA instruction 1002 executes or not. A software code profiling tool such as a profiling compiler may insert a BHINT R0 instruction 1052 directly after the move R0, targetA instruction 1002 as shown in the code sequence 1050 of FIG. 10B which would be correct approximately 90% of the time. Alternatively, using the second indirect BTA prediction circuit 900, the last instruction that affects the register R0 is adjusted 90% of the time to use the results of the move R0, targetA instruction 1002 and 10% of the time to use the results of the conditional move R0, target instruction 1006. It is noted that the execution percentages of 90% and 10% are exemplary and may be affected by other processor operations. In the case of an incorrect prediction, the correction circuit 908 of FIG. 9A may be operative to respond to an incorrect prediction.

While the invention is disclosed in the context of illustrative embodiments for use in processor systems it will be recognized that a wide variety of implementations may be employed by persons of ordinary skill in the art consistent with the above discussion and the claims which follow below. For example, both a BHINT instruction approach and an automatic indirect-target inference method, such as the second indirect BTA prediction circuit 900, for predicting an indirect branch target address may be used together. The BHINT instruction may be inserted in a code sequence, by a programmer or a software tool, such as a profiling compiler, where high confidence of indirect branch target address prediction may be obtained using this software approach. The automatic indirect-target inference method circuit is overridden upon detection of a BHINT instruction for the code sequence having the BHINT instruction.

What is claimed is:

1. A method for changing a sequential flow of a program comprising:
saving a target address identified by a first instruction; and
changing the speculative flow of execution to the target address after a second instruction is encountered, wherein the second instruction is an indirect branch instruction.

2. The method of claim 1, wherein the first instruction identifies a target address register that is specified in the indirect branch.

3. The method of claim 1 further comprising:
inserting the first instruction in a code sequence at least N program instructions prior to the indirect branch, wherein the N program instructions corresponds to the number of pipeline stages between a fetch stage and an execution stage in a processor pipeline.

4. The method of claim 1, wherein the target address is saved in a branch target address register as a result of executing the first instruction.

5. The method of claim 4, further comprising:
determining the value stored in the branch target address register is a valid instruction address; and
selecting the value from the branch target address register upon decoding the indirect branch for identifying the next instruction address to fetch.

6. The method of claim 1 further comprising:
executing the indirect branch to determine a branch target address;
comparing the determined branch target address with the target address; and
flushing a processor pipeline when the branch target address is not the same as the target address.

7. The method of claim 1 further comprising:
overriding a branch prediction circuit after the instruction is encountered.

8. The method of claim 1 further comprising:
treating the instruction as a no operation in a processor pipeline having a branch history prediction circuit with hardware resources utilized to track branches encountered during execution of a section of code; and
enabling the instruction for sections of code which exceed the hardware resources available to the branch history prediction circuit.

9. A method for predicting an indirect branch address comprising:
analyzing a sequence of instructions to identify a target address generated by an instruction of the sequence of instructions; and
preparing a predicted next program address based on the target address before an indirect branch instruction utilizing the target address is speculatively executed.

10. The method of claim 9 further comprises:
automatically identifying a target address register of the indirect branch instruction on a first pass through a section of code, wherein the identified target address register is used to automatically identify the target address generated by the instruction.

11. The method of claim 9, wherein the predicted next program address is prepared when the indirect branch instruction is in a decode pipeline stage of a processor pipeline.

12. The method of claim 9 further comprising:
inserting the instruction in a code sequence at least N program instructions prior to the indirect branch, wherein the N program instructions corresponds to the number of pipeline stages between a fetch stage and an execution stage in a processor pipeline.

13. The method of claim 9, further comprising:
loading in a first table an instruction address of the instruction that generated the target address at a target address register entry specified by the indirect branch instruction.

14. The method of claim 13, further comprising:
checking for a valid bit in an associative memory of valid bits at the instruction address; and
loading a branch target address register with a value resulting from executing the instruction that are stored in the target address register.

15. The method of claim 14, further comprising:
predicting the branch target address using the value stored in the branch target address register.

16. An apparatus for indirect branch prediction comprising:
a register for holding an instruction memory address that is specified by a program as a predicted indirect address of an indirect branch instruction; and
a next program address selector that selects the predicted indirect address from the register as the next program address for use in speculatively executing the indirect branch instruction.

17. The apparatus of claim 16 further comprises:
a decoder to decode program instructions to identify a branch target address to be stored in the register.

18. The apparatus of claim 16 further comprises:
a processor pipeline having N stages between a fetch stage and an execute stage, wherein the next program address selector selects the predicted indirect address at least the N stages prior to the indirect branch.

19. The apparatus of claim 16, wherein the predicted indirect address is based on a tracking table that stores the execution status of instructions of the program previous to the present execution cycle that affect the branch target address of the indirect branch instruction.

20. The apparatus of claim 19, wherein a predict strategy based on the tracking table is used to generate the predicted indirect address.
